(19) United States
(12) Patent Application Publication
(10) Pub. No.: US 2006/0249914 A1
(43) Pub. Date: Nov. 9, 2006

(54) Enhanced reliability sealing system

(76) Inventor: Robert D. Dulin, Kingsbury, TX (US)

Correspondence Address: Patent Office of David P. LeCroy;Attn: David LeCroy, Post Office Box 631, Manville, NJ, 08835-0631, US

(21) Appl. No.: 11/275,135

(22) Filed: Dec. 13, 2005

Related U.S. Application Data
(60) Provisional application No. 60/677,942, filed on May 6, 2005.

(51) Int. Cl. F16J 15/18

(52) U.S. Cl. 277/512

(57) ABSTRACT

An enhanced reliability sealing system is disclosed herein. The sealing system has multiple sealing elements for entrapping a lubricating agent capable of reducing or eliminating properties of a processing medium that could damage or compromise operation of the sealing system.

### CROSS REFERENCE TO RELATED APPLICATIONS

This application claims the benefit of U.S. Provisional Application No. 60/677,942, filed 6 May 2005.

### BACKGROUND OF THE INVENTION

1. Field of Invention

This invention relates to a sliding seal. More specifically, the present invention is directed towards a sliding sealing system with enhanced sealing reliability and that is self-aligning.

2. Background Information

There are many instances where a rod that is required to slide or reciprocate must extend through the wall of a pressure vessel. Common seals used in such instances include packing glands with compressible packing, rubber o-rings or lip seals. However, there are several problems that these types of seals fail to address. For example, these types of seals must be lubricated or wear and frictional heat will damage them. If the pressure vessel contains a liquid or gas medium that is sealed and has lubricating properties, the problem takes care of itself, except when the temperature of the fluid or gas being sealed falls below its individual freezing point. In such instances, the subsequent freezing and solidification can diminish the medium's inherent lubrication properties. When pressurized fluid or gas must be contained within the pressure vessel with minimal leakage, these common seals do not function well as fluids and gases have variable tendencies to leak past any given seal according to their individual seal ability.

In sealing systems the moving rod is typically close to the stationary wall of the seal. Should the temperature of the sealed medium pass through one of its phase change transition temperature (e.g., gas to liquid or liquid to solid), the change, especially from liquid to solid, can have unwanted effects upon the seal system. For example, the phase change can immobilize or bind the moving parts, or abrade the seal surfaces.

Difficulties can also occur when centering or aligning the rod that passes through the centerline of the bore of the seal, such as causing a side load. An externally induced side load can abrade or prematurely wear the sealing element, resulting in leaks in the sealing system. Therefore, it is desirable to have a sealing system without externally induced side loads.

Other problems include corrosion such as pitting of the rod, or adherence of foreign substances to the polished seal surface of the rod that slides against the resilient seal.

When process fluids or gases are used for manufacturing products, it is desirable that the process fluids or gases avoid contamination with those products, as well as avoid escaping into the environment. Therefore, it is desirable that the sealing system used in such processes both reduce or eliminate the possibility of introducing process fluid or gas contaminants into production, and the possibility of those processing fluids or gases escaping into the environment.

Preferably, such sealing systems are made from material having a high degree of chemical resistance. Further, such sealing systems are preferably constructed in a manner that results in an inherent reduction of leak paths, thereby minimizing the potential for processing fluids or gases leaking into the environment or into the manufacturing process. It is also desirable that the sealing system be manufactured from conventional materials so as to reduce the cost of manufacturing.

For example, valves have been designed with a diaphragm poppet wherein the diaphragm provides a barrier for preventing unwanted process fluid migration. Gate valves are also known in the art wherein a recess is provided in a bonnet plate or other plate around the valve stem. V-seals or the like are placed into the recess, with ducts provided through the plate to the recess for introducing a lubricant into the recess.

Still, there is a need for a sealing system having a ‘permanent’ lubricant within the system. Further, there is a need for a sealing system that is able to ‘capture’ its own lubricant, thereby reducing the likelihood of lubricant, working medium or processing fluid escaping into the environment or the manufacturing process.

### SUMMARY OF THE INVENTION

To alleviate those problems described above a seal system containing multiple sealing surfaces has been developed and tested. The system is comprised of at least two seals disposed in sequence parallel to the direction of movement of a piston or rod. The seals are placed in an appropriate holder commonly called a gland. Additional seals may be added in addition to the minimum of two in order to provide redundancy in operation of the sealing system.

Between the two or more seals is a lubricant compatible with those materials that it contacts. By placing the lubricant between the seals, it is held captive therein. As the rod shaft slides one way the lubricant is moved in the direction of one seal and upon its return the lubricant is move towards the other seal. In a system of at least three or more seals the middle seal(s) is (are) always bathed in lubricant. If the distance between the proximate and distal sealing elements is greater than distance that the rod slidably moves within the sealing system, then at least a portion of the rod or shaft is always protected from environmental or process fluid effects. In a device containing a processing medium (e.g., pressurized gas or liquid), in addition to the lubricating properties the lubricant can be chosen to be of a more viscous and easily sealable nature than the pressurized process medium, thus enhancing the sealing effect beyond that of a single seal. The pressurized medium can be any of a variety of materials according to the type of valve or device that it is associated with. For example, the pressurized medium can be a gas or liquid (e.g., hydraulic fluid) within the chamber of a cylinder such as is typically found in a gate valve.

Accordingly, the present invention provides for an enhanced reliability sealing system that includes a reciprocating rod, a retaining cylinder slidably receiving the reciprocating rod, two or more seals sequentially spaced within the retaining cylinder and slidably engageable with the reciprocating rod, a seal gland for retaining each seal at a predetermined position within an interior wall of the retaining cylinder, and a lubricating medium permanently deposited between at least any two of the seals. In one aspect the two or more seals can be equidistance from each other. In another aspect at least a portion of the reciprocating rod is always bathed in the lubricating medium.

In another embodiment the present invention is directed towards an enhanced reliability sealing system for sealing a processing medium having two or more sealing elements disposed axially along a movable rod, and a lubricating agent entrapped between each pair of sealing elements capable of providing lubrication between the seals and the movable rod. The lubricating agent is able to dilute at least small quantities of the processing medium being sealed that seep past one of the sealing elements into the lubricant thereby effecting a depression of the sealed medium's freezing point thus enabling the sealing system to operate without damage, at or below the freezing point of the sealed medium. In one aspect the two or more sealing elements and the lubricant are stationary in relation to the wall of a pressure vessel that is being sealed, and wherein the sealing is effected against the movable rod. In another aspect the two or more sealing elements and lubricant are stationary in relation to the movable rod, and wherein the sealing is effected against a wall of a pressure vessel that is being sealed. In even a further aspect more than one type of lubricating agent can be entrapped between pairs of the two or more sealing elements. In a further aspect the volume of lubricant contained between any pair of sealing elements is increased by distance or bore between the two or more sealing elements, thereby enhancing dilution capacity of the lubricant. The lubricating agent selected can further be capable of neutralizing adhesive, corrosive, polymerizing, freezing or seal degrading properties of the processing medium being sealed. In one embodiment the distance between a proximate and distal sealing element is greater than the slidable movement of the rod or shaft, thereby enclosing and protecting the sealing surface from exposure to either the environment or the process medium and their possible corrosive or otherwise degrading effects.

The present invention is also directed towards a method of sealing process fluid from the environment. This method includes disposing two or more sealing elements axially along a movable rod, and entrapping a lubricant between pairs of the two or more sealing elements. The lubricant is preferably able to neutralizing adhesive, corrosive, polymerizing, freezing or seal degrading properties inherent to the process fluid. Further, the seal is more reliable due to the redundancy of the multiple sealing elements, and is also more resistant to failure from damage caused by properties of the process fluid sealed or failure and subsequent leakage of any one seal.

In another embodiment the present invention provides for a method of sealing process fluid from the environment and the processed product. This method includes depositing at least two seals within a retaining cylinder, adding lubricating medium between the seals, and inserting a reciprocating rod through a passage disposed through the retaining cylinder, the passage having the at least two seals deposited therein. The reciprocating rod slidably engages with the at least two seals, thereby permanently capturing the lubricating medium between the seals.

The general beneficial effects described above apply generally to each of the exemplary descriptions and characterizations of the devices and mechanisms disclosed herein. The specific structures through which these benefits are delivered will be described in detail herein below.

### BRIEF DESCRIPTION OF THE DRAWINGS

FIG. 1 is an exploded perspective view of a sealing system according to the present invention.

FIG. 2 is a longitudinal cross-sectional view of a sealing system illustrating one embodiment of the present invention.

### DETAILED DESCRIPTION OF THE INVENTION

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

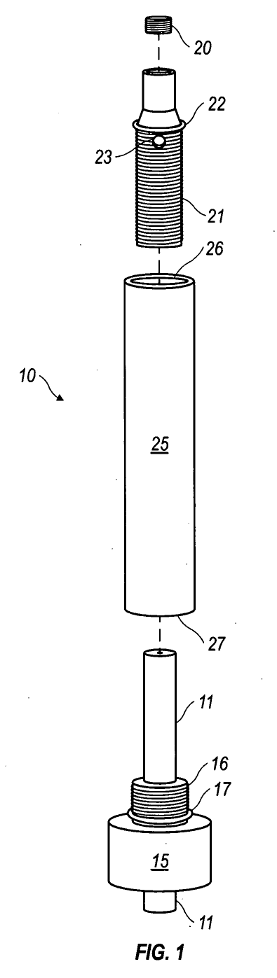

Referring to the drawings, the enhanced reliability sealing system of the present invention is indicated generally at 10. The sealing system 10 has an anterior or proximate end 20 and a posterior or distal end 15. The sealing system 10 includes a cylindrical pressure vessel 25 having a pressure chamber 28 for holding or maintaining a processing fluid or gas. In one embodiment, at least the proximate end 20 of the sealing system 10 can be integral with the pressure vessel 25. In another embodiment, the proximate end 20 is engageable with the pressure vessel 25 (e.g., by threaded engagement, snap-on, etc.). As illustrated in FIG. 1, the proximate cap 20 has a threaded portion 21 for engaging with the pressure vessel 25. In this connectable fashion, the proximate cap 20 can optionally have a cap gasket 22 for sealingly engaging with the pressure vessel 25, thereby reducing the chance of any processing fluids within the pressure vessel 25 escaping into the environment. The proximate cap 20 can further comprise a fill port 23 for input of a pressurized medium into the chamber 28 of the pressure vessel 25. The proximate end of the pressure vessel 25 can have a proximate lip 26 for engaging with the proximate gasket 22. The proximate lip 26 is preferably designed so that it is a semi-circular edge or slants inwardly away from the proximate gasket 22, thereby enhancing the seal.

The opposite or distal end of the pressure vessel 25 is engageable with a distal cap 15 (e.g., by threaded engagement, snap-on, etc.). As illustrated in FIG. 1, the distal cap 15 has a threaded portion 16 for engaging with the pressure vessel 25. In this connectable fashion, the distal cap 15 can optionally have a distal cap gasket 17 for sealingly engaging with the pressure vessel 25, thereby reducing the chance of any processing fluids within the pressure vessel 25 escaping into the environment from the distal end of the pressure vessel 25. The distal end of the pressure vessel 25 can have a distal lip 27 for engaging with the distal gasket 17. The distal lip 27 is preferably designed so that it is a semi-circular edge or slants inwardly away from the distal gasket 17, thereby enhancing the seal. In another embodiment, the distal cap 15 is integral with the pressure vessel 25.

Extending through the distal cap 15 is a piston rod 11. As illustrated in the Figures, a portion of the rod 11 is positioned within the chamber 28 of the pressure vessel 25, a portion is centrally disposed through the distal cap 15, and a portion is at least even with the base of the distal cap 15 and can extend beyond the base of the distal cap 15.

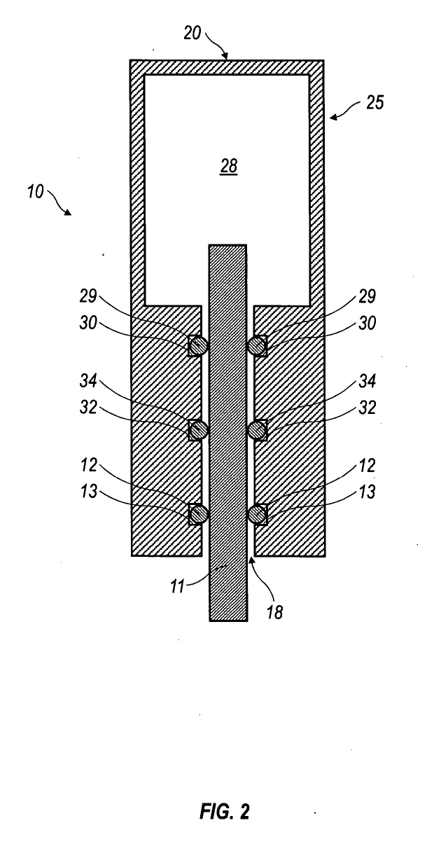

Referring to FIG. 2, a cross sectional view of the sealing system of the present invention is illustrated. As illustrated, the sealing system is comprised of three seals 12, 29, 31 disposed within the interior channel of the distal cap 15 between and in contact with the cap 15 and the piston rod 11. However, it should be understood that the sealing system of the present invention can have at least only two seals, or in a more preferred form for reasons discussed below, have more than two seals.

The seals 12, 29, 31 of the sealing system are disposed or deposited or positioned within a seal groove or gland 13, 30, 32. The glands 13, 30, 32 serve in retaining the seals 12, 29, 31 at separate positions within the distal cap 15. Those positions can be of equidistant or variable distant from each other. The seals 12, 29, 31 are in contact with both the cap 15 and the rod 11. Disposed between the seals 12, 29, 31 is a lubricant for facilitating movement of the rod 11 through the internal channel of the distal cap 15. Because of the positioning of the seals 12, 29, 31, the lubricant is ‘captured’ and retained ‘permanently’ within the space between the seals 12, 29, 31. In this manner, at least a portion of the rod 11 is in contact with the lubricant as it moves along the channel of the distal cap 15. The lubricant can further contain a corrosion retardant to preserve the polished surface of the rod 11. The lubricant can also contain a seal swelling agent to slow loss of plasticizers from the seals 12, 29, 31 themselves. The lubricant can also be chosen or additives added to the lubricant so as to inhibit polymerization, adhesion or any other degrading effect on the seal system of any process liquid that leaks between a pair of seals in the system.

For the purpose of the present invention, ‘capturing’ the lubricant refers to maintaining the lubricant or preventing it from escaping from between the seals 12, 29, 31. By stating that the lubricant is retained ‘permanently’ within the space between the seals 12, 29, 31, it is understood for the purpose of the present invention that the lubricant is added during assembly, and therefore no lubricant injection ducts are required for injecting lubricant within the space between the seals 12, 29, 31.

The distance between the first and last seal 12, 29 encloses a working portion of the polished rod 11 that, when designed in regard to the reciprocating movement necessary, is never exposed to either environment conditions or the pressurized medium. This assures that the working portion of the polished surface of the rod 11 is always protected.

The multipoint contact of the multiple seal surfaces and their spacing negates the need for a separate guide for the moving rod 11 to accommodate side loading. This inherently enhances seal reliability because proper alignment and rod-to-wall spacing is maintained.

The individual seals 12, 29, 31 within the sealing system can be made of any resilient material compatible with the lubricants, fluids and/or gasses involved. They may be configured as o-rings, square rings, u-cups, quad rings, diaphragms, wipers or any other specialized shape or combination of shapes to address specific requirements. While the Figure and above description describe the seals 12, 29, 31 as disposed in glands or grooves 13, 30, 32 in the interior diameter (‘ID’) of the bore or channel, it should be understood that they be also installed in glands or grooves on the rod 11 and slide against the ID of the bore of the distal cap 15. Also a combination of both methods could be used.

With further reference to FIG. 2, the valve 10 includes a pressure vessel 25 having a pressure vessel chamber 28. Contained within the pressure chamber 28 is a pressurized medium having properties useful in operating the valve 10. This pressurized medium can be a gas or liquid. Liquid processing mediums include semi-solid materials, such as waxes and gel-like substances. Examples of suitable processing materials for placing within the chamber 28 include hydraulic fluid, oil, water, hydrocarbon waxes and inert gases such as nitrogen, argon, etc. Suitable processing liquids include, for example, alkene hydrocarbons chosen for their individual freezing points, and whose contamination with lubricants would depress those freezing points. Tridecane, dodecane and tetradecane are examples of such hydrocarbons. One such lubricant that has proven effective with these alkene materials is multi-purpose grease (commercially available as 327 Armor Plate from Primrose Oil Co., Inc., Dallas, Tex.). The physical properties of the material should be such that under certain conditions (e.g., changes in temperature and/or pressure), the material expands or contracts. For example, in the instance of a drop in temperature, the material selected for use within the chamber 28 may contract when the temperature falls below a certain temperature (e.g., 0° C. (32° F.)). This temperature can be referred to as the setpoint temperature. The setpoint temperature can vary based on the processing material selected, as different materials can have different physical properties.

Referring again to the Figures, the operation of the valve 10 and sealing system is as follows. Above a setpoint temperature, the process medium within the pressure chamber 28 is expanded, pushing against the chamber walls and the rod 11. As the walls are fixed, only the rod 11 is able to ‘give’ with respect to the pressure of the process medium. The process medium pushes against the rod 1, causing the rod 11 to slidably move through the distal cap passage 18. The valve 10 can be connected to a biasing element (not illustrated) such as a spring that counter biases the pressure exerted by the process medium on the rod 11 extended from the chamber 28. When the temperature within the chamber 28 drop below the setpoint temperature, the processing medium contracts. Pressure from the biasing element presses against the rod 11, pushing the rod 11 back into the chamber 28. This movement of the rod 11 in and out of the chamber 28 is such that a portion of the rod 11 between the first and last seal 12, 29 is always between the seals 12, 29. In this manner, the sealed portion of the rod 11 is always lubricated.

Although the present invention has been described and illustrated in detail, it is to be clearly understood that the same is by way of illustration and example only, and is not to be taken as a limitation. The spirit and scope of the present invention are to be limited only by the terms of any claims presented hereafter.

### INDUSTRIAL APPLICABILITY

The present invention finds applicability in the valve industry, and more specifically in temperature actuated valves. Of particular importance is the invention's ability to reliably seal various materials as they go through their phase change (e.g., gas to liquid or liquid to solid) without damage to the seal.

What is claimed is:

1. An enhanced reliability sealing system comprising:
a reciprocating rod,
a retaining cylinder slidably receiving the reciprocating rod,
two or more seals sequentially spaced within the retaining cylinder and slidably engageable with the reciprocating rod,
a seal gland for retaining each seal at a predetermined position within an interior wall of the retaining cylinder, and
a lubricating medium permanently deposited between at least any two seals.

2. The sealing system of claim 1 wherein the two or more seals are equidistance from each other.

3. The sealing system of claim 1 wherein at least a portion of the reciprocating rod is always bathed in the lubricating medium.

4. An enhanced reliability sealing system for sealing a processing medium comprising:
two or more sealing elements disposed axially along a movable rod,
a lubricating agent entrapped between each pair of sealing elements capable of providing lubrication between the seals and the movable rod,
wherein the lubricating agent is able to dilute at least small quantities of the processing medium being sealed that seep past one of the sealing elements into the lubricant thereby effecting a depression of the sealed medium's freezing point enabling the sealing system to operate without damage, at or below the freezing point of the sealed medium.

5. The sealing system of claim 4 wherein the two or more sealing elements and the lubricant are stationary in relation to the wall of a pressure vessel that is being sealed, and wherein the sealing is effected against the movable rod.

6. The sealing system of claim 4 wherein the two or more sealing elements and lubricant are stationary in relation to the movable rod, and wherein the sealing is effected against a wall of a pressure vessel that is being sealed.

7. The sealing system of claim 4 wherein more than one type of lubricating agent is entrapped between pairs of the two or more sealing elements.

8. The sealing system of claim 4 where the volume of lubricant contained between any pair of sealing elements is increased by distance or bore between the two or more sealing elements, thereby enhancing dilution capacity of the lubricant.

9. The sealing system of claim 4 wherein the lubricating agent is capable of neutralizing adhesive, corrosive, polymerizing, freezing or seal degrading properties of the processing medium being sealed.

10. The sealing system of claim 4 wherein the distance between a proximate and distal sealing element is greater than the slidable movement of the rod or shaft, thereby enclosing and protecting the sealing surface from exposure to either the environment or the process medium and their possible corrosive or otherwise degrading effects.

11. A method of sealing process fluid from the environment, the method comprising the steps of:
disposing two or more sealing elements axially along a movable rod, and
entrapping a lubricant between pairs of the two or more sealing elements;
wherein the lubricant is able to neutralizing adhesive, corrosive, polymerizing, freezing or seal degrading properties inherent to the process fluid;
wherein the seal is more reliable due to the redundancy of the multiple sealing elements and is more resistant to failure from damage caused by properties of the process fluid sealed or failure and subsequent leakage of any one seal.

12. The method according to claim 11 further comprising the steps of:
inserting a reciprocating rod through a passage disposed through the retaining cylinder, the passage having the at least two seals deposited therein;
wherein the reciprocating rod slidably engages with the at least two seals, thereby permanently capturing the lubricating medium between the seals.
